(19) United States
(12) Patent Application Publication
(10) Pub. No.: US 2023/0106136 A1
(43) Pub. Date: Apr. 6, 2023

(54) ELECTRONIC APPARATUS AND GENERATING METHOD OF TARGET DOMAIN

(71) Applicant: Samsung Electronics Co., Ltd., Suwon-si (KR)

(72) Inventors: Sangyeon KIM, Suwon-si (KR); Hyunwoo LEE, Suwon-si (KR); Jonghee HAN, Suwon-si (KR)

(21) Appl. No.: 17/875,937

(22) Filed: Jul. 28, 2022

Related U.S. Application Data
(63) Continuation of application No. PCT/KR2022/008970, filed on Jun. 23, 2022.

(30) Foreign Application Priority Data
Oct. 6, 2021 (KR) 10-2021-0132670
Mar. 16, 2022 (KR) 10-2022-0033031

(51) Int. Cl. G06N 3/04; G06N 3/08

(52) U.S. Cl. CPC G06N 3/0454; G06N 3/08

(57) ABSTRACT

An electronic apparatus generating a generative adversarial network (GAN)-based target domain and a generating method thereof is provided. The generating method includes reconstructing source data included in a source domain, generating target data by training the reconstructed source data based on the source data, and generating a target domain including the generated target data, and the training comprises identifying at least one loss value between a class loss value by class loss and a distance loss value by distance matrix loss and applying at least one loss value between the identified class loss value and the distance loss value to the reconstructed source data.

### CROSS-REFERENCE TO RELATED APPLICATION(S)

This application is a continuation application, claiming priority under § 365(c), of an International application No. PCT/KR2022/008970, filed on Jun. 23, 2022, which is based on and claims the benefit of a Korean patent application number 10-2021-0132670, filed on Oct. 6, 2021, in the Korean Intellectual Property Office, and of a Korean patent application number 10-2022-0033031, filed on Mar. 16, 2022, in the Korean Intellectual Property Office, the disclosure of each of which is incorporated by reference herein in its entirety.

### BACKGROUND

### 1. Field

The disclosure relates to an electronic apparatus and a generating method of a target domain. More particularly, the disclosure relates to an electronic apparatus for moving a domain and a generating method of a target domain.

### 2. Description of Related Art

As the importance of big data in the industry increases, various efficient ways of using data have emerged. With the development of electronic apparatuses of various specifications, new electronic apparatuses of different specifications must be subject to new data according to an object model (target model). However, the initial data applied to the target model of the new electronic apparatus may be insufficient. Therefore, it has been conducted research on how to compensate for the lack of data, and domain transfer or domain adaptation technologies have been studied as a method. In particular, with the development of Generative Adversarial Networks (GAN), research to analyze the relationship between a small amount of data in the target domain and a large amount of data in the source domain to generate a variety of data in the target domain has been conducted.

For example, recently studied methods may generate fake data that are very similar to real data using GAN. However, if the target model is initially trained with the data generated in the GAN, the accuracy in the target domain is reduced. The biggest reason that the accuracy decreases in the target domain is that the features of the source data trained by the existing source model may be changed in the transformed target data or the features have different distributions. In particular, the loss of the GAN that transforms an image more realistically is trained to transform it like real data regardless of the features reflected in the source model, so the feature distribution of the target data is very different from the feature distribution of the source model. That is, the feature to be seen as real data and the feature reflected in the source model may be different.

Therefore, there is a need for a method in which source data of a source model may be trained by reflecting existing information of a source model to a target model using various loss functions when transforming source data of a source model into target data of a target model.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic apparatus for learning by reflecting information of source data of a source model to a target model, and a method for generating a target domain.

Additional aspects will be set forth in part in the description which follows and, in part, will be apparent from the description, or may be learned by practice of the presented embodiments.

In accordance with an aspect of the disclosure, a generating method of a generative adversarial network (GAN)-based target domain is provided. The generating method includes reconstructing source data included in a source domain, generating target data by training the reconstructed source data based on the source data, and generating target domain including the generated target data, and the generating the target data may include identifying at least one loss value between a class loss value by class loss and a distance loss value by distance matrix loss and applying at least one loss value between the identified class loss value and the distance loss value to the reconstructed source data.

In accordance with another aspect of the disclosure, an electronic apparatus generating a generative adversarial network (GAN)-based target domain is provided. The electronic apparatus includes an input interface, and a processor, and the processor may receive source data included in a source domain through the input interface, reconstruct source data included in the source domain, generate a target domain by training the reconstructed source data based on the source data, generate a target domain including the generated target data, and the processor may identify at least one loss value between a class loss value by class loss and a distance loss value by distance matrix loss and apply at least one loss value between the identified class loss value and the distance loss value to the reconstructed source data.

In accordance with another aspect of the disclosure, a non-transitory computer readable storage medium recorded with a program for executing a generating method of a generative adversarial network (GAN)-based target domain is provided. The non-transitory computer readable storage medium includes reconstructing source data included in a source domain, generating target data by training the reconstructed source data based on the source data, and generating a target domain including the generated target data, and the generating the target data may include generating the target data comprises identifying at least one loss value between a class loss value by class loss and a distance loss value by distance matrix loss and applying at least one loss value between the identified class loss value and the distance loss value to the reconstructed source data.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWING FIGURES

The above and other aspects, features, and advantages of certain embodiments of the disclosure will be more apparent from the following description taken in conjunction with the accompanying drawings, in which:

FIG. 1 is a block diagram illustrating a configuration of an electronic apparatus according to an embodiment of the disclosure;

FIG. 2 is a block diagram illustrating a specific configuration of an electronic apparatus according to an embodiment of the disclosure;

FIG. 3 is a diagram illustrating an embodiment of the GAN according to an embodiment of the disclosure;

FIG. 4 is a diagram illustrating a loss module according to an embodiment of the disclosure;

FIG. 5 is a diagram illustrating a difference between an existing model and a model to which the loss of the disclosure is applied according to an embodiment of the disclosure; and

FIG. 6 is a flowchart illustrating a method of generating a target domain according to an embodiment of the disclosure.

Throughout the drawings, it should be noted that like reference numbers are used to depict the same or similar elements, features, and structures.

### DETAILED DESCRIPTION OF THE EMBODIMENTS

The following description with reference to the accompanying drawings is provided to assist in a comprehensive understanding of various embodiments of the disclosure defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms, such as the first, second, etc., may be used to describe various components, but these components are not limited by the terms discussed above. The terms described above are used only to distinguish one component from another component.

It should be understood that the terms “include,” “comprise,” and the like are intended to specify the presence or addition of features, numbers, steps, operations, components, parts, or combinations thereof, as described herein, but do not preclude the presence or addition of one or more other features or numbers, steps, operations, components, parts, or combinations thereof. It should be understood that, while certain components are “connected” or “coupled” to other components, they may be directly connected to or coupled to the other components, although other components may be present therebetween. On the other hand, when certain components are referred to as being “directly connected” or “directly coupled” to other components, it should be understood that there are no other components therebetween.

The terms “module” or “unit” for the components used herein perform at least one function or operation. The terms “module” or “unit” may perform a function or operation by hardware, software, or a combination of hardware and software. Further, a plurality of “modules” or a plurality of “units” other than the “module” or “unit” that should be performed in a particular hardware or performed in at least one processor may be integrated into at least one module.

In the description of the disclosure, the order of each step should be understood nonrestrictively unless a preceding step must be performed before a subsequent step logically and temporally. That is, except for the exceptional case above, although a process described as a subsequent step is performed before a process described as a preceding step, it does not affect the essence of the disclosure and the scope of the disclosure should be defined regardless of order of steps. Also, description of “A or B” is defined to mean that both A and B are included, as well as selectively indicating any one of A and B. Also, the term “including” in this specification has a comprehensive meaning to further include another component in addition to elements enumerated to be included.

In this specification, only essential components necessary for the description of the disclosure are described and components not related to the essence of the disclosure are not mentioned. Also, only the mentioned components should not be construed to be included in an exclusive sense but should be construed in a non exclusive sense to include any other component.

In the description of the disclosure, if it is determined that the detailed description of the related known functions or configurations may obscure the subject matter of the disclosure, a detailed description thereof will be shortened or omitted. On the other hand, each embodiment may be implemented or operated independently, although each embodiment may be implemented or operated in combination.

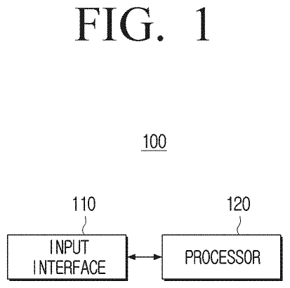

FIG. 1 is a block diagram illustrating a configuration of an electronic apparatus according to an embodiment of the disclosure.

Referring to FIG. 1, an electronic apparatus 100 may include an input interface 110 and a processor 120.

The input interface 110 may receive a signal from the outside. For example, the input interface 110 may be implemented as a keypad, a touch pad, a touch screen, or the like, and may receive a control signal from a user. The electronic apparatus 100 may perform a control operation according to an input control signal. Alternatively, the input interface 110 may include a communication interface in a broad sense. When the input interface 110 includes a communication interface, the input interface 110 may communicate with an external device in a wired/wireless communication scheme (or a communication standard). For example, the input interface 110 may communicate with an external device in at least one of a wireless communication scheme of Wi-Fi, Wi-Fi direct, Bluetooth, Zigbee, 3rd generation (3G), 3rd generation partnership project (3GPP), or long term evolution (LTE), or at least one wired communication method such as a small computer system interface (SCSI), a universal serial bus (USB), Institute of Electrical and Electronics Engineers (IEEE) 1394, serial AT attachment (e-SATA), Thunderbolt, and a wired local area network (LAN). The input interface 110 may receive source data included in the source domain from an external device. For example, the input interface 110 may be referred to as an input device, an input unit, an input module, or the like.

The processor 120 may control each configuration of the electronic apparatus 100. For example, the processor 120 may control the input interface 110 to receive source data included in a source domain.

The processor 120 may include an artificial intelligence (AI) neural network model implemented as GAN, and may generate a target domain including target data used in the included AI neural network model. The processor 120 may reconstruct the source data included in the source domain. The processor 120 may train the reconstructed source data based on the source data to generate target data and generate a target domain including the generated target data. The GAN model may be trained to convert the data like real data regardless of a characteristic reflected to the source data. Therefore, the electronic apparatus 100 trained with the target data generated based on the source data may have decreased accuracy since the characteristics of the real data and the characteristics reflecting the source data may be different. For example, the source domain may be a domain generated in an AI learning model of an external electronic apparatus, and the target domain may be a domain for an AI learning model of the electronic apparatus. The external electronic apparatus and the electronic apparatus may have different hardware specifications, software platforms, software versions, and the like. The learning model (or learning data) trained in the external electronic apparatus and may have a high accuracy may have degraded performance of the learning model in the electronic apparatus when the learning model (or learning data) is used (or trained) as it is in the electronic apparatus.

In order to improve accuracy of the electronic apparatus 100 trained with the target data generated based on the source data, the processor 120 may apply various loss values to the reconstructed source data.

For example, the processor 120 may identify a class loss value by class loss, a distance loss value due to a distance matrix loss. The processor 120 may apply the identified loss value to the reconstructed source data to generate target data. The processor 120 may additionally identify a cluster loss value due to a cluster loss, a class activating mapping (CAM) loss value due to a CAM loss, a feature loss value due to feature loss, and the like. The processor 120 may additionally apply the identified cluster loss value, CAM loss value, feature loss value, etc. to the reconstructed source data to generate target data. A detailed description of each loss will be described later.

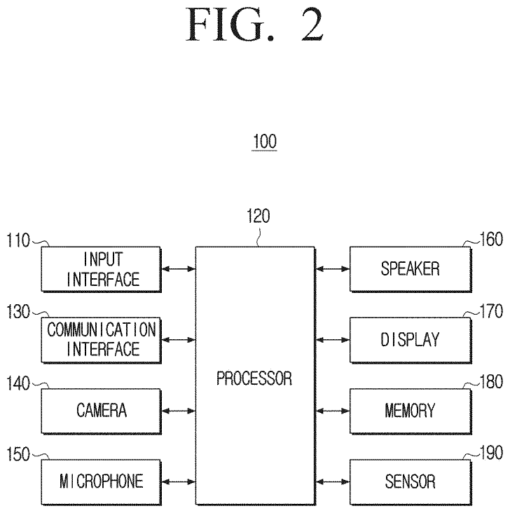

FIG. 2 is a block diagram illustrating a specific configuration of an electronic apparatus according to an embodiment of the disclosure.

Referring to FIG. 2, the electronic apparatus 100 may include the input interface 110, the processor 120, a communication interface 130, a camera 140, a microphone 150, a speaker 160, a display 170, a memory 180, and a sensor 190. The input interface 110 is the same as illustrated in FIG. 1, and the communication interface 130 may be included in the input interface 110 in a broader sensor and thus, a detailed description will be omitted.

The camera 140 may capture a surrounding environment including the user. The processor 120 may obtain information about a surrounding environment, information about an image of a user, and the like on the basis of the image captured by the camera 140. The processor 120 may perform a corresponding operation based on the obtained information. Alternatively, the processor 120 may identify information obtained based on the obtained information and an artificial intelligence neural network model (e.g., a GAN model). For example, the camera 140 may include a charge-couple device (CCD) sensor, a complementary metal-oxide semiconductor (CMOS) sensor. The camera 140 may include a red-green-blue (RGB) camera, a depth camera, a wide angle camera, a telephoto camera, and the like.

The microphone 150 may receive a sound of a user or a sound of a surrounding environment. The processor 120 may perform a corresponding operation based on a sound of an input user or a sound of a surrounding environment. Alternatively, the processor 120 may identify a sound obtained based on the obtained sound and an artificial intelligence neural network model (e.g., a GAN model). For example, the microphone 150 may include a general microphone, a surround microphone, a directional microphone, and the like.

The speaker 160 may output a sound signal. For example, the speaker 160 may output information on an input command of a user, information on a warning, information on a state of the electronic apparatus 100, or information on an operation, or the like, as a voice or an alarm sound.

The display 170 may output data processed in the processor 120 as video. The display 170 may display information and may output a screen corresponding to the recognized command of a user. For example, the display 170 may be implemented as a liquid crystal display (LCD), an organic light emitting diode (OLED), a flexible display, a touch screen, or the like. When the display 170 is implemented with a touch screen, the electronic apparatus 100 may receive a control command through a touch screen.

The memory 180 may store data and algorithm, or the like, to perform a function of the electronic apparatus 100, and may store a program, an instruction, or the like, driven by the electronic apparatus 100. The memory 180 may store AI neural network model (or algorithm), or the like. For example, the memory 180 may be implemented as a read only memory (ROM), a random access memory (RAM), a hard disk drive (HDD), a solid state drive (SSD), a memory card, or the like.

For example, the sensor 190 may include an image sensor, a motion recognition sensor, a proximity sensor, a thermal sensor, a touch sensor, an infrared sensor, an ultrasonic sensor, a geomagnetic sensor a gravity sensor, acceleration sensor, and the like.

The configuration of the electronic apparatus 100 has been described. Hereinbelow, a process of generating a target domain including target data by the electronic apparatus 100 will be described.

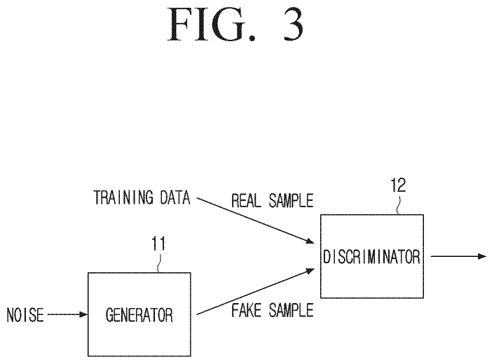

FIG. 3 is a diagram illustrating an embodiment of the GAN according to an embodiment of the disclosure.

The AI neural network model may be implemented with the GAN. The GAN includes a generator 11 and a discriminator 12. For example, the generator may receive random distribution such as Gaussian distribution and may generate fake data. The discriminator 12 may receive trained real data and the generated fake data and may discriminate whether the input data is real data or fake data.

According to an embodiment, the GAN may generate a batch of the fake image through the generator 11 for learning of the discriminator 12, sample batch of the same size in the training data, and combine the two batches. A value of 0 may be assigned to a fake image, and 1 may be assigned to the real data. In the process of learning of the discriminator 12, the weight of the discriminator 12 may be updated. However, the weight of the generator 11 is not updated because the weight of the updated discriminator 12 does not perform reverse propagation. The GAN may generate the batch of the fake image through the generator 11 for learning of the generator 11. The GAN may set the label of the batch of the fake image to 1 without adding the actual image and determine the discriminator 12. The reverse propagation proceeds to the generator 11 and the weight of the generator is updated, but the weight of the discriminator 12 maintains the existing value. Through the above-described process, the generator 11 may be trained to generate fake data close to the real data, and the discriminator 12 may be trained to determine real data and fake data, thereby improving the discrimination performance of the GAN. Since the generator 11 and the discriminator 12 are trained in different directions, the GAN may be referred to as an adversarial network. The GAN may generate the fake data which is mostly same as the existing source data and train the discriminator 12 to train the artificial intelligence neural network model using a small amount of data. GAN may not be reflected with a target model or may have no target model, since the GAN is to generate the fake data as real data.

Accordingly, the disclosure may improve performance (or discrimination performance of an artificial intelligence neural network based on a target domain) that generates a target domain by applying various loss functions considering source data and a target model while maintaining the advantages of GAN that trains an artificial intelligence neural network model using a small amount of data.

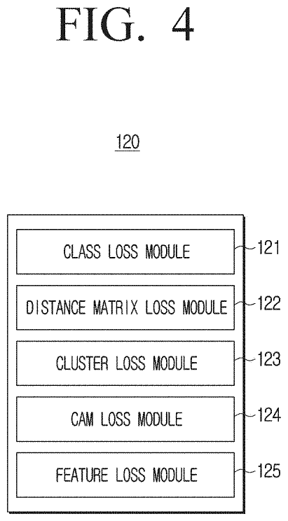

FIG. 4 is a diagram illustrating a loss module according to an embodiment of the disclosure.

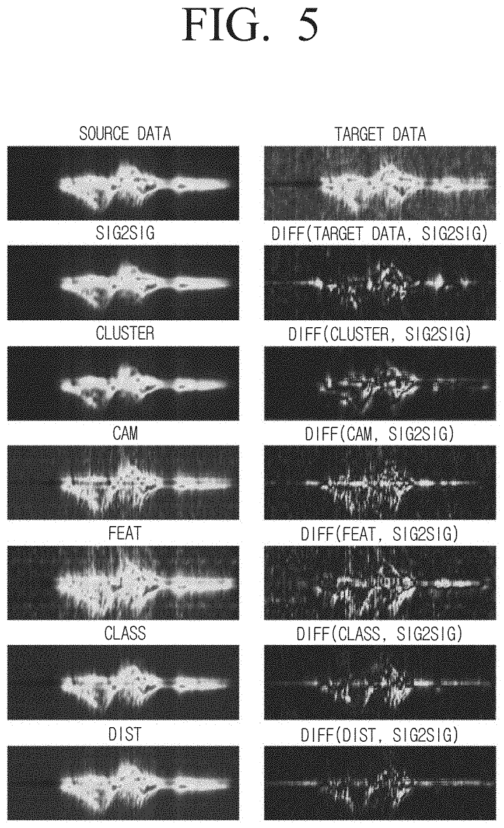

FIG. 5 is a diagram illustrating a difference between an existing model and a model to which the loss of the disclosure is applied according to an embodiment of the disclosure. The embodiment will be described with reference to FIGS. 4 and 5.

Referring to FIG. 4, the processor 120 may include a class loss module 121, a distance matrix loss module 122, a cluster loss module 123, a CAM loss module 124, and a feature loss module 125. For example, the processor 120 may include the class loss module 121 and/or the distance matrix loss module 122. Alternatively, the processor 120 may include one or more other loss modules 123, 124, 125, in addition to the class loss module 121 and/or the distance matrix loss module 122. Each loss module may be implemented with software. Referring to FIG. 4, each loss module is shown as a separate module in FIG. 4, but each loss module may be implemented with a single loss module and may operate in conjunction with each other. Each loss module (or one loss module) may be stored in a memory and loaded into the processor 120 in the memory when the processor 120 trains an artificial intelligence neural network model.

The class loss module 121 may obtain a class loss value. The class loss module 121 may identify a first class loss value according to a predetermined method when the category of classes for the reconstructed source data corresponding to the source data is matched based on a class including source data among a plurality of classes, and may identify a second class loss value according to a preset method when the category of classes for the reconstructed source data is not matched, and obtain a class loss value. The second class loss value may be a value greater than the first class loss value. According to one embodiment, if the source data is classified as an A class and the reconstructed source data is classified as A class, the class loss module 121 may determine that the categories of classes match. If the source data is classified as A-class and the reconstructed source data is classified into a B-class, the class loss module 121 may determine that the categories of classes are not matched.

The distribution of feature vectors in the source model may be different. Therefore, the class loss may have an effect similar to the adversarial loss by simply maintaining the class when the learning of the distribution of the feature vector is difficult. Although the adversarial loss in the GAN model is to distinguish between true and false, it may be helpful to generate a more detailed portion of the class that is important to the data generated through the GAN model in the case of class loss. In one embodiment, the class loss may be calculated using Equation 1.

L_{class}=C(M_{source}(x_{fake}^{A}),label(xᵣₑₐₗ^{A}))+C(M_{source}(x_{recon}^{A}),label(xᵣₑₐₗ^{A})) . . . Equation 1

Where C is a cost function of the source model, and a categorical cross entropy may be used. x_{fake}^{A} refers to fake source data and x_{recon}^{A} refers to the reconstructed source data. Msource refers to a source model trained using data in a large amount of source domain. The Msource(x) may output a probability distribution value for each class when the data x is input to the source model. The label(x) refers to a true label value of x. According to an embodiment, if the source model is a model to classify “dog” and “cat,” and label(xᵣₑₐₗ^{A}) is “dog,”. label(xᵣₑₐₗ^{A})=[1,0], M_{source}(x_{fake}^{A})=[0.7, 0.3]. The difference between two vectors may be calculated by using cost function of Equation 1. The GAN model may be trained so that M_{source}(x_{fake}^{A}) approaches [1, 0]. The class loss may allow the class of data converted in the target model to be classified well. Since the class loss is simpler than other losses, the learning of GAN may be facilitated. However, as the class loss is simple and thus if trained with only class loss, the distribution of data in the source domain and data in the target domain may be different.

The distance matrix loss module 122 may obtain a distance loss value. As described above, when the GAN is trained with only class loss, the distribution of the data in the source domain and the data in the target domain may vary, and thus the electronic apparatus may similarly generate distribution of the data of the source domain and the data of the target domain using the distance loss. The distance matrix loss module 122 may identify a distance map based on a distance between feature vectors of source data included in different classes of the plurality of classes. The distance matrix loss module 122 may obtain a distance loss value such that the distance between the feature vectors of the reconstructed source data corresponding to the source data is maintained based on the identified distance map.

For a distance loss, the feature vector distribution of the original data may enable affine transformation to the feature vector. Since the distance loss has difference in terms of source data and target data, if it is difficult to learn the feature loss, the feature loss may be replaced, and a relatively guaranteed conversion learning may be performed. In one embodiment, the distance loss may be calculated using Equation 2.

L_{dist}=∥dist(fc(xᵣₑₐₗ^{A}))−dist(fc(x_{fake}^{B}))∥+∥dist(fc(x_{fake}^{A}))−dist(fc(x_{recon}^{B}))∥ . . . Equation2

Where dist( ) refers to a distance map of the feature vectors that have passed through the source model.

The GAN model may generate the fake target data (.x_{fake}^{B}) of the target domain. The GAN may be trained so that xᵣₑₐₗ^{B} [symbol] , x_{fake}^{B} [symbol] , x_{recon}^{B} in order to create the fake target data x_{fake}^{B} generated in the direction of A->B well. x_{recon}^{B} refers to reconstructed data of the target domain and may be obtained from .x_{fake}^{A}. Therefore, the GAN model may be trained in A->B direction for learning of the fake source data (.x_{fake}^{A}), reconstructed data (x_{recon}^{B}) of the target domain, and also may be trained in B->A direction (xᵣₑₐₗ^{A} [symbol] x_{fake}^{A} [symbol] x_{recon}^{A}).

The cluster loss module 123 may obtain a cluster loss value. The cluster loss module 123 may obtain a cluster loss value based on a predetermined method so that the distance between the feature vectors of the reconstructed source data included in different classes among the plurality of classes is spaced apart from each other.

For example, if the first data is classified as a class A class, and the second data is classified into a class B class, the cluster loss module 123 may obtain a cluster loss value so that the class is clearly distinguished by sufficiently separating the distance between the first data and the second data. That is, in order to improve the performance of the classification model using the generated data, the cluster loss module 123 may separate data belonging to different classes from the target domain, such as in the source domain. In one embodiment, cluster loss may be calculated using Equations 3 and 4.

L_{cluster}=1/∥Enc_{A}_{_{i,}}_{B}_{ᵢ}−Enc_{A}_{_{j,}}_{B}_{ⱼ}∥ . . . Equation3

Where i, j is different class of classification model.

Enc_{A,B}=mean(G_{AB}^{feat}(A),G_{BA}^{feat}(B)) . . . Equation4

Where Gfeat is a flat vector of the bottom part of U-net.

G_{AB}^{feat}(A) refers to the feature (key feature of A data) obtained by encoding A data in the direction of A->B, and G_{BA}^{feat}(B) refers to the feature (key feature of B data) obtained by encoding B data in the direction of B->A. That is, Equation 3 means that loss is reduced when an average value of a key feature of A and a key feature of B for data included in each of class i and j is calculated, the model is trained so that the loss becomes small when spaced apart from another class.

The CAM loss module 124 may obtain the CAM loss value. The CAM loss module 124 may identify a weight region of the source data to be applied when the artificial intelligence neural network learning model including the source domain classifies the class of source data. The CAM loss module 124 may obtain a CAM loss value for setting a weight region of the reconstructed source data corresponding to the identified source data. If the target model is to learn very similarly to the source model so that performance is high, it is necessary to learn the functions of the source data that the source model considers important. As an embodiment, when determining falldown of a human, if the source model considers movement of the head portion of the human important, the target model also needs to be trained by adding a weight to movement of the head portion of the human.

For example, a GradCAM may be used to obtain important data information of the source model. The CAM loss module 124 may use the activated parts using the GradCAM as a weight for each image when the image is trained. That is, the CAM loss module 124 may more specifically generate the feature portion that the source model considers important. For example, the weight region may be a particular region of image data or a particular frequency domain of signal data. In one embodiment, CAM loss may be calculated using Equation 5.

L_{cam}= [symbol] ᵢ=A,B[∥(xᵣₑₐₗⁱ−x_{recon}ⁱ)·CAM(xᵣₑₐₗⁱ)∥] . . . Equation5

Where cam(x) is an activation map of data x which is obtained by GradCAM through the source model. Script I may be A or B.

The feature loss module 125 may obtain a feature loss value. The feature loss module 125 may obtain a feature loss value such that a feature vector of the source data and a feature vector of the reconstructed source data corresponding to the source data are the same. In one embodiment, feature loss may be calculated using Equation 6.

L_{feat}= [symbol] ᵢ=A,B[∥fc(xᵣₑₐₗⁱ)−fc(x_{fake}ⁱ)∥]+ [symbol] ᵢ=A,B[∥fc(xᵣₑₐₗⁱ)−fc(x_{recon}ⁱ)∥] . . . Equation6

Where fc is a fully connected layer of the source model before classification layer. A typical artificial intelligence model includes a fully connected (fc) layer that gathers main features in the last step. Equation 6 refers to an fc (x) layer process, and an artificial intelligence model of the disclosure may output a main feature vector through Equation 6.

Referring to FIG. 5, there is shown a diagram of comparing existing conversion data with data generated by applying each loss of the disclosure. The difference between the existing conversion data and the conversion data according to the disclosure may be slight, but a slight difference may appear in the main feature portion. For example, the model according to the disclosure may more specifically generate the main feature portion of the target data since the loss of the portion where the source model emphasizes is more strongly reflected in the case of CAM loss. In addition, the model according to the disclosure may apply a feature loss to maintain a distance between features of the source model. Therefore, as shown in FIG. 5, many portions of the conversion data of the disclosure have been modified differently from existing transform data. Even in the case of class loss and distance loss, the conversion data according to the disclosure may be specifically expressed as compared to existing conversion data.

Various loss methods to generate target data similar to source data have been described. Hereinbelow, a method of generating a target domain will be described.

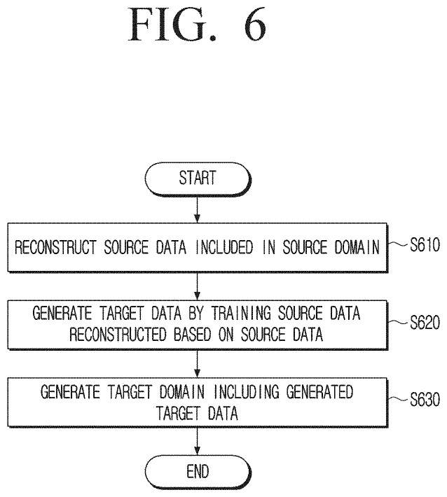

FIG. 6 is a flowchart illustrating a method of generating a target domain according to an embodiment of the disclosure.

Referring to FIG. 6, an electronic apparatus for generating a GAN-based target domain may reconstruct source data included in a source domain in operation S610. For example, the source domain may be a domain generated in an artificial intelligence learning model of the first electronic apparatus, and the target domain may be a domain for an artificial intelligence learning model of the second electronic apparatus. The first electronic apparatus and the second electronic apparatus may be apparatuses having different hardware specifications, software platforms, software versions, etc.

The electronic apparatus may train the reconstructed source data based on the source data to generate target data in operation S620. For example, the electronic apparatus may identify a class loss value by class loss, a distance loss value due to a distance matrix loss. The electronic apparatus may apply the identified loss value to the reconstructed source data. The electronic apparatus may additionally identify a cluster loss value due to a cluster loss, a CAM loss value due to CAM loss, a feature loss value due to feature loss, and the like, and additionally apply the identified at least one type of loss value to the reconstructed source data.

According to an embodiment, the electronic apparatus may determine whether the class classification for the reconstructed source data corresponding to the source data is identical based on the class including the source data among the plurality of classes. The electronic apparatus may identify a first class loss value according to a preset method when the classification of a class for the reconstructed source data matches, and identify a second class loss value according to a preset method when the class of classes for the reconstructed source data is not matched, thereby obtaining a class loss value. The second class loss value may be a value greater than the first class loss value.

The electronic apparatus may identify a distance map based on a distance between feature vectors of source data included in different classes of the plurality of classes. The electronic apparatus may obtain a distance loss value such that the distance between the feature vectors of the reconstructed source data corresponding to the source data is maintained based on the identified distance map.

The electronic apparatus may obtain a cluster loss value based on a method preset so that distance of the feature vector of the reconstructed source data included in different classes among the plurality of classes becomes apart.

In addition, the electronic apparatus may identify a weight region of the source data to be applied when the artificial intelligence neural network learning model including the source domain classifies the class of source data. The electronic apparatus may obtain a CAM loss value for setting a weight region of the reconstructed source data corresponding to the identified source data. For example, the weight region may include a particular region of image data, a particular frequency region of signal data, and the like.

The electronic apparatus may obtain a feature loss value so that the feature vector of the source data is the same as the feature vector of the reconstructed source data corresponding to the source data.

The electronic apparatus may generate a target domain including the generated target data in operation S630. Through the above-described process, the electronic apparatus may generate a target domain in which learning performance is maintained by using source data of the source domain.

The method of generating a target domain according to various embodiments may be provided as a computer program. The program product may include an S/W program or a non-transitory computer readable medium stored with the S/W program.

The non-transitory computer-recordable medium is not a medium configured to temporarily store data such as a register, a cache, or a memory but an apparatus-readable medium configured to semi-permanently store data. Specifically, the above-described various applications or programs may be stored in the non-transitory apparatus-readable medium such as a compact disc (CD), a digital versatile disc (DVD), a hard disc, a Blu-ray disc, a USB, a memory card, or a ROM, and provided therein.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A generating method of a generative adversarial network (GAN)-based target domain, the generating method comprising:
reconstructing source data included in a source domain;
generating target data by training the reconstructed source data based on the source data; and
generating the target domain including the generated target data,
wherein the generating of the target data comprises identifying at least one loss value of a class loss value by class loss or a distance loss value by distance matrix loss, and applying at least one loss value of the identified class loss value or the identified distance loss value to the reconstructed source data.

2. The method of claim 1,
wherein the generating of the target data comprises:
based on a category of a class for the reconstructed source data corresponding to the source data being matched based on a class including the source data among a plurality of classes, identifying a first class loss value according to a preset method, and
based on the category of the class for the reconstructed source data not being matched, identifying a second class loss value according to the preset method to obtain a second class loss value, and
wherein the second class loss value is greater than the first class loss value.

3. The method of claim 1, wherein the generating of the target data further comprises:
identifying a distance map based on a distance between feature vectors of source data included in different classes among a plurality of classes; and
obtaining the distance loss value so as to maintain a distance between the feature vectors of the reconstructed source data corresponding to the source data based on the identified distance map.

4. The method of claim 1, wherein the generating of the target data further comprises:
identifying at least one loss value among a cluster loss value by cluster loss, a class activating mapping (CAM) loss value by CAM loss, or a feature loss value by feature loss; and
additionally applying at least one loss value among the identified cluster loss value, CAM loss value, or feature loss value to the reconstructed source data.

5. The method of claim 4, wherein the generating of the target data further comprises obtaining a cluster loss value based on a preset method so that a distance of feature vectors of the reconstructed source data included in different classes among a plurality of classes is far apart.

6. The method of claim 4, wherein the generating of the target data further comprises:
identifying a weight region of the source data to be applied when classifying a class of the source data by an artificial intelligence neural network model including the source domain; and
obtaining a CAM loss value to set the weight region of the reconstructed source data corresponding to the identified source data.

7. The method of claim 6, wherein the weight region comprises at least one region of a specific region of image data or a specific frequency region of signal data.

8. The method of claim 4, wherein the generating of the target data further comprises obtaining the feature loss value so that a feature vector of the source data is the same as a feature vector of the reconstructed source data corresponding to the source data.

9. The method of claim 1,
wherein the source domain is a domain generated in an artificial intelligence learning model of a first electronic apparatus,
wherein the target domain is a domain for an artificial intelligence learning model of a second electronic apparatus, and
wherein the first electronic apparatus and the second electronic apparatus have at least one different hardware specification, software platform, or software version.

10. The method of claim 1,
wherein the generating of the target data further comprises:
receiving Gaussian distribution, and
generating fake data, and
wherein the method further comprises:
receiving trained real data and the generated fake data, and
discriminating whether input data is the real data or the fake data.

11. The method of claim 10, wherein the fake data is generated to be close to the real data.

12. An electronic apparatus generating a generative adversarial network (GAN)-based target domain, the electronic apparatus comprising:
an input interface; and
a processor,
wherein the processor is configured to:
receive source data included in a source domain through the input interface,
reconstruct source data included in the source domain,
generate a target domain by training the reconstructed source data based on the received source data,
generate a target domain including the generated target data,
identify at least one loss value of a class loss value by class loss or a distance loss value by distance matrix loss, and
apply at least one loss value of the identified class loss value or the identified distance loss value to the reconstructed source data.

13. The electronic apparatus of claim 12, wherein the processor is further configured to:
based on a category of a class for the reconstructed source data corresponding to the source data being matched based on a class including the source data among a plurality of classes, identify a first class loss value according to a preset method; and
based on the category of the class for the reconstructed source data not being matched, identify a second class loss value according to the preset method to obtain a second class loss value, wherein the second class loss value is greater than the first class loss value.

14. The electronic apparatus of claim 12, wherein the processor is further configured to:
identify a distance map based on a distance between feature vectors of source data included in different classes among a plurality of classes; and
obtain the distance loss value so as to maintain a distance between the feature vectors of the reconstructed source data corresponding to the source data based on the identified distance map.

15. The electronic apparatus of claim 12, wherein the processor is further configured to obtain a cluster loss value based on a preset method so that a distance of feature vectors of the reconstructed source data included in different classes among a plurality of classes is far apart.

16. The electronic apparatus of claim 12, wherein the processor is further configured to:
identify at least one loss value among a cluster loss value by cluster loss, a class activating mapping (CAM) loss value by CAM loss, or a feature loss value by feature loss; and
additionally apply at least one loss value among the identified cluster loss value, CAM loss value, or feature loss value to the reconstructed source data.

17. The electronic apparatus of claim 16, wherein the processor is further configured to:
identify a weight region of the source data to be applied when classifying a class of the source data by an artificial intelligence neural network model including the source domain; and
obtain a CAM loss value to set the weight region of the reconstructed source data corresponding to the identified source data.
